(19) United States
(12) Patent Application Publication
(10) Pub. No.: US 2025/0296042 A1
(43) Pub. Date: Sep. 25, 2025

(54) EXHAUST GAS TREATMENT APPARATUS, EXHAUST GAS TREATMENT METHOD, AND METHOD FOR PRODUCING SULFIDE COMPOUND

(71) Applicant: Dexerials Corporation, Shimotsuke-Shi (JP)

(72) Inventors: Toru Matsunaga, Shimotsuke-Shi (JP); Mitsuharu Sugawara, Shimotsuke-Shi (JP)

(73) Assignee: Dexerials Corporation, Shimotsuke-Shi (JP)

(21) Appl. No.: 19/082,819

(22) Filed: Mar. 18, 2025

(30) Foreign Application Priority Data
Mar. 19, 2024 (JP) 2024-043768

(51) Int. Cl. B01D 53/75; B01D 53/50; B01D 53/52; B01D 53/76; B01D 53/78; C01B 17/20

(52) U.S. Cl. CPC B01D 53/75; B01D 53/501; B01D 53/52; B01D 53/76; B01D 53/78; C01B 17/20; B01D 2251/304; B01D 2251/604; B01D 2257/302; B01D 2257/304

(57) ABSTRACT

Provided is an apparatus for treating an exhaust gas containing hydrogen sulfide, the apparatus comprising: a combustion furnace configured to combust the hydrogen sulfide contained in the exhaust gas to convert the hydrogen sulfide into sulfur dioxide; and a scrubber configured to convert the sulfur dioxide produced in the combustion furnace into a sulfite by contacting the sulfur dioxide with an alkaline aqueous solution. The combustion furnace comprises a first introduction pipe for introducing the exhaust gas, a second introduction pipe for introducing a combustible gas and a combustion supporting gas, and a combustion chamber connected to the first introduction pipe and the second introduction pipe, and a component constituting the combustion chamber has a surface including quartz glass on an inside of the combustion chamber.

This application is based on and claims the benefit of priority from Japanese Patent Application No. 2024-043768, filed on 19 Mar. 2024, the content of which is incorporated herein by reference.

### BACKGROUND OF THE INVENTION

### Field of the Invention

The present invention relates to an exhaust gas treatment apparatus, an exhaust gas treatment method, and a method for producing a sulfide compound.

### Related Art

In the past, sulfide compounds have been used in phosphors for cathode-ray tube TVs, and in recent years, in photocatalysts for artificial photosynthesis and solid electrolytes for all-solid-state batteries. When synthesizing these sulfide compounds, a major issue is how to supply the sulfur source necessary for the reaction. From the viewpoints of flexibility in reaction temperature and mass production, a method for synthesizing sulfide compounds by continuously supplying and reacting hydrogen sulfide has been desired.

On the other hand, hydrogen sulfide is a toxic gas and a combustible gas, and is a substance subject to regulation by various laws. Therefore, although various safety measures are indispensable for handling hydrogen sulfide, there are few opportunities to industrially use a raw material gas containing hydrogen sulfide at a high concentration, and there is no method for treating an exhaust gas containing hydrogen sulfide at a high concentration. Here, hydrogen sulfide has a rotten egg odor and is therefore subject to the Offensive Odor Prevention Law, but the concentration at which humans no longer perceive it as an offensive odor is extremely low, 0.02 ppm by volume or less.

Japanese Unexamined Patent Application, Publication No. H10-54534 discloses a combustion-type exhaust gas treatment apparatus that performs detoxification treatment by ejecting an exhaust gas containing harmful components into a combustion chamber and combusting the exhaust gas. Here, in the combustion-type exhaust gas treatment apparatus, the combustion chamber is formed of a double wall structure including an inner wall and an outer wall. The inner wall is formed of a porous material, and a gas introduction part for introducing a pressure gas is provided between the inner wall and the outer wall. As the porous material, a stainless steel sintered metal having a nominal filtration accuracy of 100 μm is used.

Patent Document 1: Japanese Unexamined Patent Application, Publication No. H10-54534

### SUMMARY OF THE INVENTION

However, when an exhaust gas containing a high concentration of hydrogen sulfide is treated at a high temperature using the combustion-type exhaust gas treatment apparatus disclosed in Japanese Unexamined Patent Application, Publication No. H10-54534, the inner wall of the combustion chamber corrodes, and as a result, the inner wall of the combustion chamber becomes damaged. Additionally, sulfur dioxide, which is produced by the combustion of hydrogen sulfide, needs to be abated because emission standards are set by the Air Pollution Control Law.

An object of the present invention is to provide an exhaust gas treatment apparatus capable of suppressing damage to components constituting a combustion chamber and abating sulfur dioxide even when treating an exhaust gas containing a high concentration of hydrogen sulfide at high temperatures.

A first aspect of the present invention is an apparatus for treating an exhaust gas containing hydrogen sulfide. The apparatus includes a combustion furnace configured to combust the hydrogen sulfide contained in the exhaust gas to convert the hydrogen sulfide into sulfur dioxide, and a scrubber configured to convert the sulfur dioxide produced in the combustion furnace into a sulfite by contacting the sulfur dioxide with an alkaline aqueous solution. The combustion furnace includes a first introduction pipe for introducing the exhaust gas, a second introduction pipe for introducing a combustible gas and a combustion supporting gas, and a combustion chamber connected to the first introduction pipe and the second introduction pipe. A component constituting the combustion chamber has a surface including quartz glass on an inside of the combustion chamber.

A second aspect of the present invention is a method for treating the exhaust gas using the apparatus according to the first aspect. The exhaust gas has a concentration of the hydrogen sulfide of 20% by volume or more. A combustion temperature of the hydrogen sulfide is 670° C. or higher and 1000° C. or lower.

In a third aspect of the method according to the second aspect, the alkaline aqueous solution has a pH of 12.1 or more and 12.3 or less.

In a fourth aspect of the method according to the second or third aspect, in the alkaline aqueous solution, the concentrations of the sulfite and a carbonate generated by contacting the alkaline aqueous solution with carbon dioxide are 50% or less of solubilities of the sulfite and the carbonate in water, respectively.

A fifth aspect of the present invention is a method for producing a sulfide compound. The method includes continuously supplying hydrogen sulfide and reacting the hydrogen sulfide to synthesize the sulfide compound, and treating an exhaust gas discharged during synthesis of the sulfide compound by the method according to any one of the second to fourth aspects.

According to the present invention, it is possible to provide an exhaust gas treatment apparatus capable of suppressing damage to components constituting a combustion chamber and abating sulfur dioxide even when treating an exhaust gas containing a high concentration of hydrogen sulfide at high temperatures.

### BRIEF DESCRIPTION OF THE DRAWINGS

FIG. 1 is a schematic view showing an exhaust gas treatment apparatus according to an embodiment of the present invention;

FIG. 2 is a partial cross-sectional schematic view showing the main components of a combustion furnace of FIG. 1;

FIG. 3A is a partial enlarged cross-sectional view of the combustion furnace of FIG. 2; and

FIG. 3B is a partial enlarged top view of the combustion furnace of FIG. 2.

### DETAILED DESCRIPTION OF THE INVENTION

Hereinafter, an embodiment of the present invention will be described with reference to the drawings.

### [Exhaust Gas Treatment Apparatus]

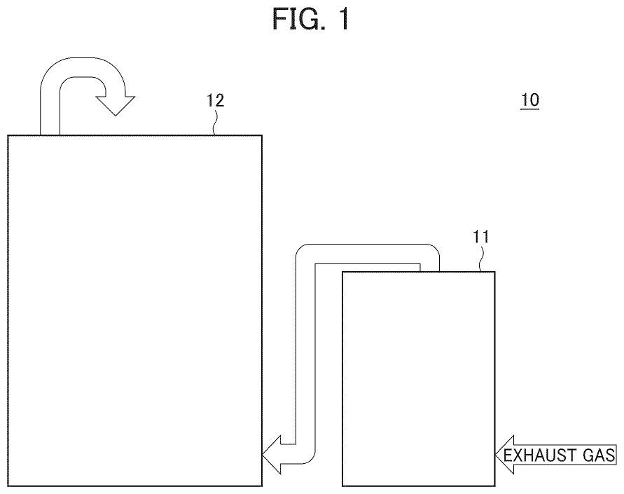

FIG. 1 shows an exhaust gas treatment apparatus according to an embodiment of the present invention.

An exhaust gas treatment apparatus 10 is an apparatus for treating an exhaust gas containing hydrogen sulfide, and includes a combustion furnace 11 that combusts hydrogen sulfide contained in the exhaust gas to convert the hydrogen sulfide into sulfur dioxide, and a scrubber 12 that converts the sulfur dioxide produced in the combustion furnace 11 into a sulfite by contacting the sulfur dioxide with an alkaline aqueous solution. Thus, sulfur dioxide, which is produced in the combustion furnace 11, is abated.

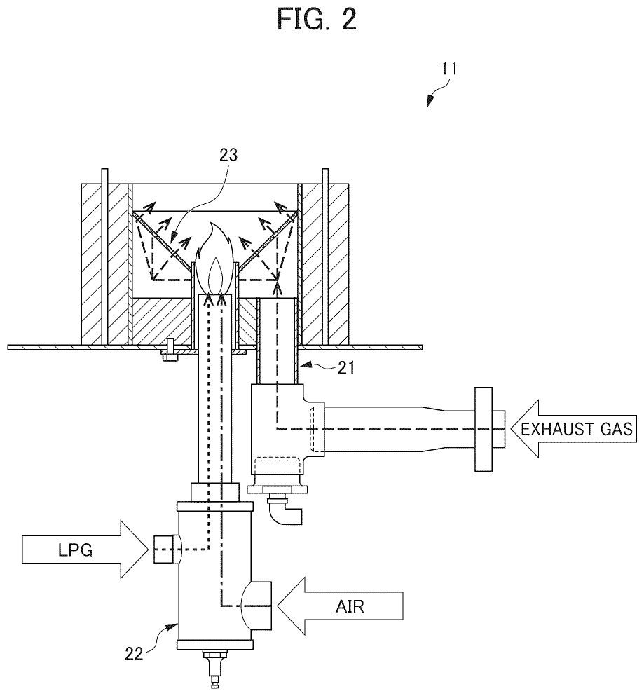

As shown in FIG. 2, the combustion furnace 11 includes a first introduction pipe 21 for introducing exhaust gas, a second introduction pipe 22 for introducing combustible gas (e.g., liquefied petroleum gas (LPG)) and combustion supporting gas (e.g., air), and a combustion chamber 23 connected to the first introduction pipe 21 and the second introduction pipe 22. At this time, the second introduction pipe 22 includes an ignition mechanism. Here, the components constituting the combustion chamber 23 have surfaces including quartz glass on the inside of the combustion chamber 23. That is, the components constituting the combustion chamber 23 includes quartz glass, or the surfaces of the components on the inside of the combustion chamber 23 are coated with quartz glass. Therefore, even when the exhaust gas containing a high concentration of hydrogen sulfide is treated at high temperatures, damage to the components constituting the combustion chamber 23 due to corrosion is suppressed.

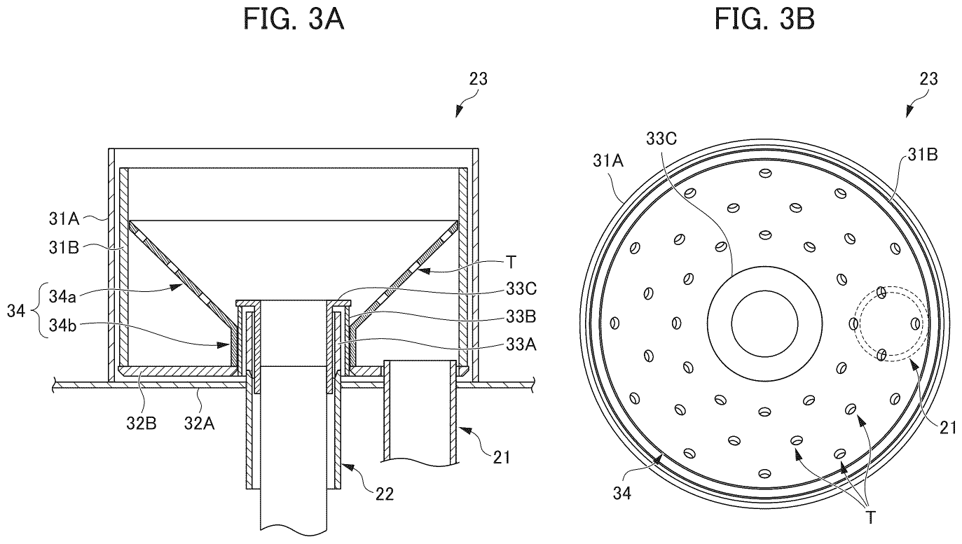

As shown in FIGS. 3A and 3B, in the combustion chamber 23, an outer cylinder 31B made of quartz glass is fitted to an inner surface of an outer cylinder 31A made of stainless steel. Further, in the combustion chamber 23, a bottom plate 32B made of quartz glass is fitted to an upper surface of a bottom plate 32A made of stainless steel. Further, in the combustion chamber 23, an inner cylinder 33B made of quartz glass and a lidded inner cylinder 33C made of quartz glass are respectively fitted to an outer surface and an inner surface of an inner cylinder 33A made of stainless steel extending from a connection part with the second introduction pipe 22. Here, the lid of the lidded inner cylinder 33C is in contact with the upper surface of the inner cylinder 33A. Further, in the combustion chamber 23, a cone-shaped member 34 made of quartz glass is fitted to the outer cylinder 31B and the inner cylinder 33B that are made of quartz glass. Here, the cone-shaped member 34 includes a cone part 34a and a cylindrical part 34b, and through holes T are formed in the cone part 34a. At this time, the through holes T serve as flow paths of the exhaust gas introduced from the first introduction pipe 21 into the combustion chamber 23.

The scrubber 12 is not limited as long as it can convert sulfur dioxide into a sulfite by contacting the sulfur dioxide with an alkaline aqueous solution, and a known scrubber can be used. Examples of commercially available products of the scrubber include wet scrubber SC-100 (manufactured by Seikow Chemical Engineering & Machinery, Ltd.).

### [Exhaust Gas Treatment Method]

The exhaust gas treatment method of the present embodiment is a method for treating an exhaust gas containing hydrogen sulfide using the exhaust gas treatment apparatus 10. The concentration of hydrogen sulfide in the exhaust gas is 20% by volume or more and 100% by volume or less.

First, a method for converting hydrogen sulfide contained in an exhaust gas into sulfur dioxide by combusting the hydrogen sulfide using the combustion furnace 11 will be described. In the combustion chamber 23, the combustible gas introduced from the second introduction pipe 22 is combusted to generate a flame, and hydrogen sulfide is combusted above the flame. The combustion temperature of hydrogen sulfide is 670° C. or higher and 1000° C. or lower. At this time, the combustion temperature of hydrogen sulfide is adjusted by the amounts of the combustible gas and the combustion supporting gas introduced. The method for detecting the combustion temperature of hydrogen sulfide is not limited, and examples thereof include a method in which a thermocouple is placed in the hydrogen sulfide combustion region. The concentration of hydrogen sulfide in the combustion chamber 23 is within the combustion range of hydrogen sulfide (4.3% by volume or more and 46% by volume or less). At this time, the concentration of hydrogen sulfide in the combustion chamber 23 is adjusted by the amounts of the exhaust gas and the combustion supporting gas introduced.

The combustible gas is not limited as long as it can combust to generate a flame, and examples thereof include LPG. The combustion supporting gas is not limited as long as it can combust the combustible gas and hydrogen sulfide, and examples thereof include air.

Next, a method for converting sulfur dioxide produced in the combustion furnace 11 into a sulfite by contacting the sulfur dioxide with an alkaline aqueous solution using the scrubber 12 will be described.

The alkaline aqueous solution is not limited as long as it can convert sulfur dioxide into a sulfite, and examples thereof include a sodium hydroxide aqueous solution.

The pH of the alkaline aqueous solution is 12.1 or more and 12.3 or less. When the pH of the alkaline aqueous solution is less than 12.1, sulfur dioxide is less likely to be converted into a sulfite at a desired reaction rate, and when the pH exceeds 12.3, a glass electrode of a pH meter for measuring the pH of the alkaline aqueous solution cannot be used for a long period of time.

The method for controlling the pH of the alkaline aqueous solution is not limited, and examples thereof include a method of replenishing the alkaline aqueous solution with a concentrated alkaline aqueous solution or water based on a measured value of the pH of the alkaline aqueous solution, and a method of replacing the alkaline aqueous solution.

In the exhaust gas treatment method of the present embodiment, since the combustible gas is combusted in the combustion chamber 23 to generate carbon dioxide, the combustion gas discharged from the combustion furnace 11 always contains carbon dioxide. Therefore, when the sulfur dioxide produced in the combustion furnace 11 is brought into contact with the alkaline aqueous solution, the carbon dioxide comes into contact with the alkaline aqueous solution and is converted into a carbonate. As a result, when the concentration of the sulfite (or carbonate) in the alkaline aqueous solution exceeds 50% of the solubility of the sulfite (or carbonate) in water, sulfur dioxide may not be easily converted into a sulfite. Therefore, it is preferable that the concentrations of the sulfite and the carbonate in the alkaline aqueous solution are 50% or less of the solubilities of the sulfite and the carbonate in water in the alkaline aqueous solution, respectively.

The method for controlling the concentrations of the sulfite and the carbonate in the alkaline aqueous solution is not limited, and examples thereof include a method of replenishing the alkaline aqueous solution with a concentrated alkaline aqueous solution or water at a predetermined timing based on the amounts of sulfur dioxide and carbon dioxide introduced into the scrubber 12, and a method of replacing the alkaline aqueous solution.

The exhaust gas treatment method of the present embodiment can be applied to, for example, treatment of an exhaust gas discharged when hydrogen sulfide is continuously supplied and reacted to synthesize a known sulfide compound.

Although the embodiment of the present invention has been described above, the present invention is not limited to the above-described embodiment, and the above-described embodiment may be modified as appropriate within the scope of the gist of the present invention.

### EXAMPLES

Next, examples of the present invention will be described, but the present invention is not limited to the examples.

### Comparative Example 1

Hydrogen sulfide was treated using the combustion furnace 11 of the exhaust gas treatment apparatus 10. Specifically, hydrogen sulfide was combusted and converted into sulfur dioxide using the combustion furnace 11. At this time, hydrogen sulfide (10 L/min) was introduced and air (30 L/min) was introduced to adjust the concentration of hydrogen sulfide in the combustion chamber 23 to 25% by volume. Further, the amounts of LPG and air introduced were controlled using a thermocouple placed in the hydrogen sulfide combustion region so that the temperature of the combustion chamber 23 was 670°° C. or higher and 1000° C. or lower. Next, air (20 m³/min) was introduced into the combustion gas discharged from the combustion chamber 23 to dilute it.

### Example 1

The treated gas of Comparative Example 1 was introduced into the scrubber 12 of the exhaust gas treatment apparatus 10 at a rate of 20 m³/min and was brought into contact with a sodium hydroxide aqueous solution to be converted into sodium sulfite. At this time, the pH of the sodium hydroxide aqueous solution was controlled to be 12.1 or more and 12.3 or less using a pH controller HBM-100A (manufactured by DKK-TOA CORPORATION) placed in the scrubber 12. Specifically, the sodium hydroxide aqueous solution was replenished with a concentrated sodium hydroxide aqueous solution based on the measured pH value. Further, the concentrations of sodium sulfite and sodium carbonate in the sodium hydroxide aqueous solution were controlled to be 50% or less (150 g/L or less and 90 g/L or less) of the solubilities of the sodium sulfite and sodium carbonate in water at the liquid temperature (20° C.) in the sodium hydroxide aqueous solution, respectively. Specifically, water was supplied to the sodium hydroxide aqueous solution at a predetermined timing based on the amounts of sulfur dioxide and carbon dioxide introduced into the scrubber 12.

### Comparative Example 2

Hydrogen sulfide was treated in the same manner as in Comparative Example 1 except that the components made of quartz glass constituting the combustion chamber 23 was replaced with components made of stainless steel (SUS304).

### [Concentrations of Hydrogen Sulfide, Sulfur Dioxide and Carbon Dioxide in Treated Gas]

The concentrations of hydrogen sulfide, sulfur dioxide, and carbon dioxide in the gas were measured using a detector tube (manufactured by GASTEC CORPORATION) or the like.

### [Degree of Damage to Components Constituting Combustion Chamber]

When the cumulative use time of the combustion furnace 11 reached 300 hours, the degree of damage to the components constituting the combustion chamber 23 was visually evaluated.

Table 1 shows the evaluation results of the concentrations of hydrogen sulfide, sulfur dioxide, and carbon dioxide in the treated gas and the degree of damage to the components constituting the combustion chamber.

TABLE 1

| | | | Degree of damage | | | |
|---|---|---|---|---|---|---|
| | Surfaces on | | to components | | | |
| | inside of | | constituting | | | |
| | combustion | | combustion | Concentration | Concentration | Concentration |
| | chamber | Scrubber | chamber [%] | of H₂S [ppb] | of SO₂ [ppm] | of CO₂ [ppm] |
| Example 1 | Quartz glass | Used | 0 | <10 | <5 | — |
| Comparative | Quartz glass | Not used | 0 | <10 | 500 | 1000 |
| Example 1 | | | | | | |
| Comparative | SUS304 | Not used | 40 | — | — | — |
| Example 2 | | | | | | |

It can be seen from Table 1 that, in Example 1, even when hydrogen sulfide is treated at a high temperature, damage to the components constituting the combustion chamber 23 is suppressed, and sulfur dioxide is abated. In contrast, in Comparative Example 1, sulfur dioxide is not abated because the scrubber 12 is not used. In Comparative Example 2, since SUS304 is present on the surfaces on the inside of the combustion chamber 23, the components constituting the combustion chamber 23 are damaged.

### EXPLANATION OF REFERENCE NUMERALS

10 exhaust gas treatment apparatus
11 combustion furnace
12 scrubber
21 first introduction tube
22 second introduction tube
23 combustion chamber
31A, 31B outer cylinder
32A, 32B bottom plate
33A, 33B inner cylinder
33C lidded inner cylinder
34 cone-shaped member
34a cone part
34b cylindrical part
T through hole

What is claimed is:

1. An apparatus for treating an exhaust gas containing hydrogen sulfide, the apparatus comprising:
a combustion furnace configured to combust the hydrogen sulfide contained in the exhaust gas to convert the hydrogen sulfide into sulfur dioxide; and
a scrubber configured to convert the sulfur dioxide produced in the combustion furnace into a sulfite by contacting the sulfur dioxide with an alkaline aqueous solution,
wherein the combustion furnace comprises a first introduction pipe for introducing the exhaust gas, a second introduction pipe for introducing a combustible gas and a combustion supporting gas, and a combustion chamber connected to the first introduction pipe and the second introduction pipe, and
wherein a component constituting the combustion chamber has a surface including quartz glass on an inside of the combustion chamber.

2. A method for treating the exhaust gas using the apparatus according to claim 1,
wherein the exhaust gas has a concentration of the hydrogen sulfide of 20% by volume or more, and
wherein a combustion temperature of the hydrogen sulfide is 670° C. or higher and 1000° C. or lower.

3. The method according to claim 2, wherein the alkaline aqueous solution has a pH of 12.1 or more and 12.3 or less.

4. The method according to claim 2, wherein in the alkaline aqueous solution, the concentrations of the sulfite and a carbonate generated by contacting the alkaline aqueous solution with carbon dioxide are 50% or less of solubilities of the sulfite and the carbonate in water, respectively.

5. A method for producing a sulfide compound, comprising:
continuously supplying hydrogen sulfide and reacting the hydrogen sulfide to synthesize the sulfide compound; and
treating an exhaust gas discharged during synthesis of the sulfide compound by the method according to claim 2.
